(19) United States
(12) Patent Application Publication
(10) Pub. No.: US 2016/0318170 A1
(43) Pub. Date: Nov. 3, 2016

(54) Extension Wrench

(71) Applicant: Maxx Leverage, Delray Beach, FL (US)

(72) Inventor: Gerald Shane Mulligan, Boise, ID (US)

(21) Appl. No.: 15/197,422

(22) Filed: Jun. 29, 2016

Related U.S. Application Data
(63) Continuation-in-part of application No. 13/999,059, filed on Mar. 4, 2014.

(51) Int. Cl. B25G 1/00; B25B 23/16

(52) U.S. Cl. CPC B25G 1/005; B25B 23/16

(57) ABSTRACT

An extension wrench includes a handle and a wrench securing head. The extension wrench firmly engages and locks in place with an open-end wrench through a first lateral plate, a second lateral plate, and a pair of locking pins of the wrench securing head. Then the handle is utilized to effectively apply pressure to the open-end wrench as the handle is axially connected with the wrench securing head. The wrench securing head is also partially angled away from a central axis of the handle, allowing the extension wrench to be utilized within a zero-degree position angle to a 90-degree position angle.

The current application is a continuation-in-part (CIP) application of the U.S. non-provisional application Ser. No. 13/999,059 filed on Mar. 4, 2014.

### FIELD OF THE INVENTION

The present invention relates generally to an extension wrench. More specifically, the present invention is an extension wrench that effectively and safely engages with an open-end wrench to provide additional leverage.

### BACKGROUND OF THE INVENTION

Currently, there is a lack of quality and effective tools that can provide additional leverage for an open-end wrench. Although there are several existing extension tools are available within the tool industry, each existing extension tool is not able to fully comply with the open-end wrench. For example, even though most of the existing extension tools are able to engage with the open-end wrench, they are not able to fully lock in place with the open-end wrench. As a result, these existing extension tools tend to slip and disengage when force is applied. Additionally, some existing extension tools lack proper surface area for gripping. As a result, the user is not able to fully utilize those extension tools when required. Furthermore, some existing extension tools require intermediary tool components to adequately engage with the open-end wrench. Use of intermediary tool components create a cumbersome assembly and unnecessary failure points within the cumbersome assembly, creating an unsafe work environment for the user.

It is an objective of the present invention to provide an extension wrench that effectively and safely engages with an open-end wrench. The present invention is manufactured in the field of mechanics, aircraft, auto, tractor, and any other related tool industry to provide the full scope of a completed tool that can effectively and safely engage with the open-end wrench. More specifically, a wrench securing head of the present invention provides a secured engagement between the present invention and the open-end wrench. A handle of the present invention is able to provide proper grip and leverage in order to effectively rotate the open-end wrench.

### BRIEF DESCRIPTION OF THE DRAWINGS

FIG. 1 is a perspective view of the present invention.

FIG. 2 is a side view of the present invention.

FIG. 3 is a top view of the present invention.

FIG. 4 is a side view of the present invention showing the zero-degree position angle.

FIG. 5 is a side view of the present invention showing the 90-degree position angle.

### DETAIL DESCRIPTIONS OF THE INVENTION

All illustrations of the drawings are for the purpose of describing selected versions of the present invention and are not intended to limit the scope of the present invention.

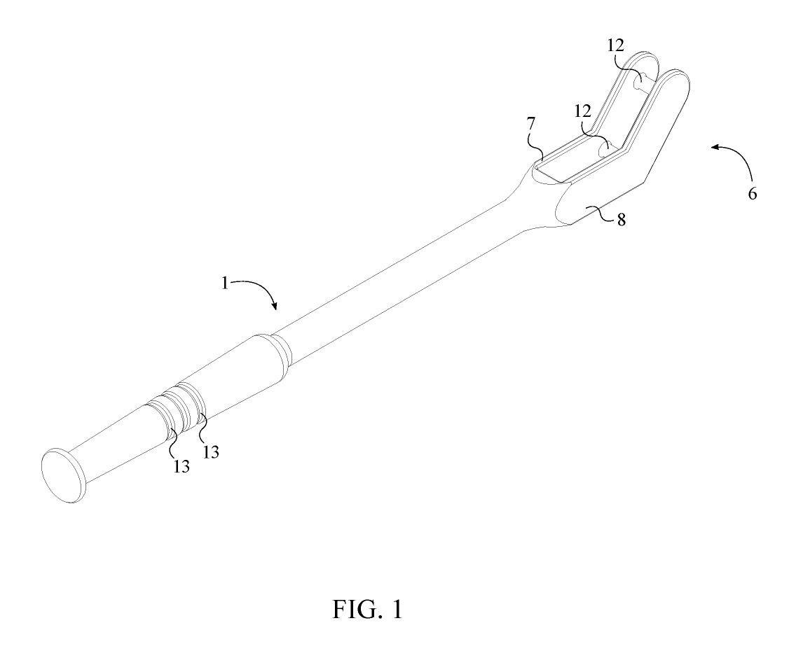

The present invention is an extension wrench that safely and effectively engages with an open-end wrench to provide additional leverage. The present invention is of solid material construction and does not utilize any moving or removable components. The present invention locks in place with the open-end wrench when forward pressure is applied and releases from the open-end wrench when pressure is reversed. In reference to FIG. 1, the present invention comprises a handle 1 and a wrench securing head 6. The handle 1 is axially connected to the wrench securing head 6. The wrench securing head 6 engages and locks in place with the open-end wrench, and the handle 1 provides the necessary length and the surface area for the user to grasp the present invention. As a result, the user is able effectively apply pressure to the open-end wrench through the wrench securing head 6 and the handle 1. Even though the present invention is described in relation to the open-end wrench, it is to be understood that the present invention can also be used in relation to a close end wrench. Additionally, the present invention is also compatible with a full set of metric wrenches and a full set of standard wrenches.

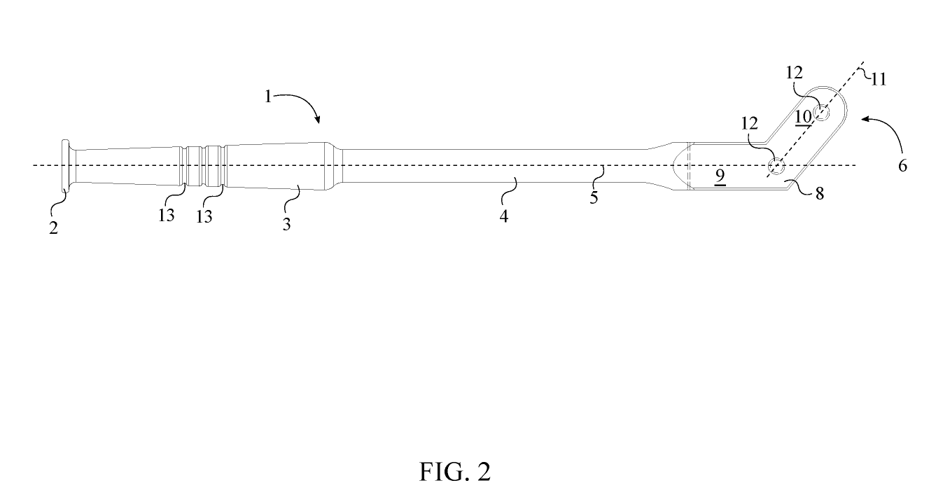

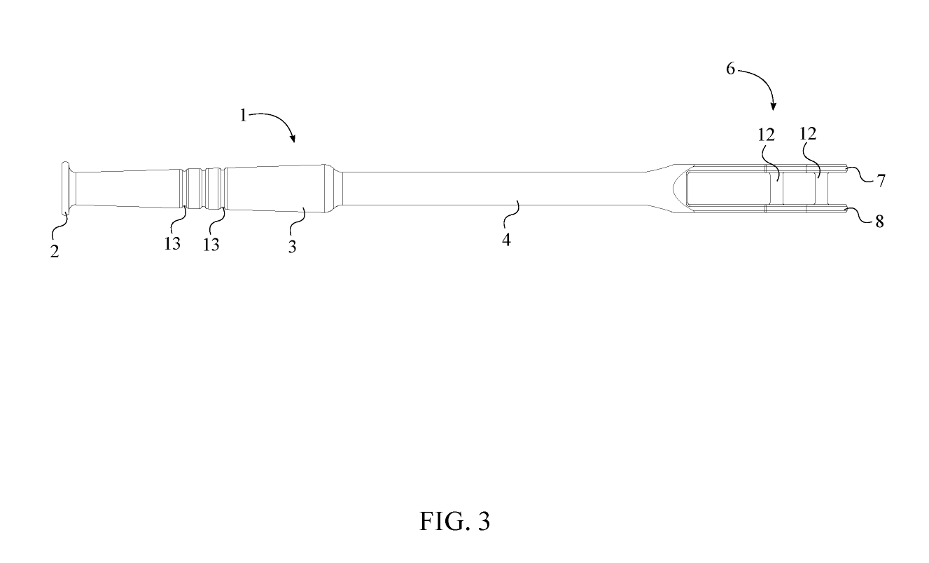

The handle 1 is an elongated member and is completed with multiple sections to provide multiple functionalities within the present invention. Each of those functionality is explained with respect to the specific section of the handle 1 hereafter. In reference to FIG. 2-3, the handle 1 comprises a pommel end 2, a grip section 3, and an extended section 4. The pommel end 2, the grip section 3, and the extended section 4 are axially oriented along a central axis 5 of the handle 1. As a result, the pommel end 2 is adjacently positioned with the grip section 3. The extended section 4 is adjacently positioned with the grip section 3, opposite of the pommel end 2. Ergonomic shapes of the pommel end 2 and the grip section 3 allow the user to grasp the present invention with the user's hands. More specifically, the user utilizes one hand to secure the pommel end 2 while the other hand is utilized to secure the grip section 3. The grip section 3 provides sufficient griping surface for the user so that the user can fully grasp the handle 1. The pommel 2 also improves the gripping ability of the handle 1 and guards against slip potential of the handle 1. The length of the extended section 4 may vary from one embodiment to another in order to increase or decrease the lever arm of the present invention. In other words, the extended section 4 determines different overall lengths of the present invention as the extended section 4 functions as the connection shaft member between the grip section 3 and the wrench securing head 6.

In reference to FIG. 2, the present invention further comprises a plurality of grooves 13 so that the user is able to apply the required amount of force to the present invention without generating slippage. In other words, the plurality of grooves 13 provides optimal grip ability for the present invention as the plurality of grooves 13 is distributed along the grip section 3. As a result, the user is able to create a stable grip around the handle 1 during the operation of the present invention. More specifically, the plurality of grooves 13 is traversed into the grip section 3 and radially positioned around the grip section 3. In reference to preferred embodiment of the present invention, the plurality of grooves 13 is centrally positioned with the grip section 3. As a result, the plurality of grooves 13 is able to comfortably and ergonomically position within the palm of the user's hand. In reference to an alternative embodiment of the present invention, the plurality of grooves 13 comprises a first set of grooves and a second set of grooves. The first set of grooves is adjacently positioned with the pommel end 2, and the second set of grooves is adjacently positioned with the extended section 4. As a result, the first set of grooves and the second set of grooves are able to collectively retain the user's hand around the grip section 3 minimizing the slippage within the present invention. Even though the plurality of grooves 13 is separated into the first set of grooves and the second set of grooves within the alternative embodiment, the present invention can include any number of grooves within the grip section 3 as long as the plurality of grooves 13 improves friction between the handle 1 and the user's hand.

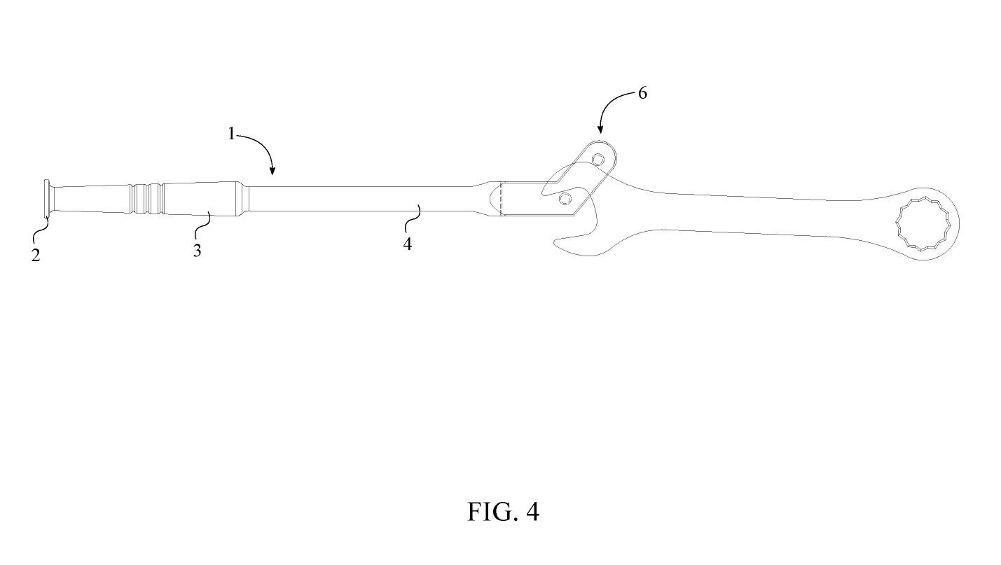

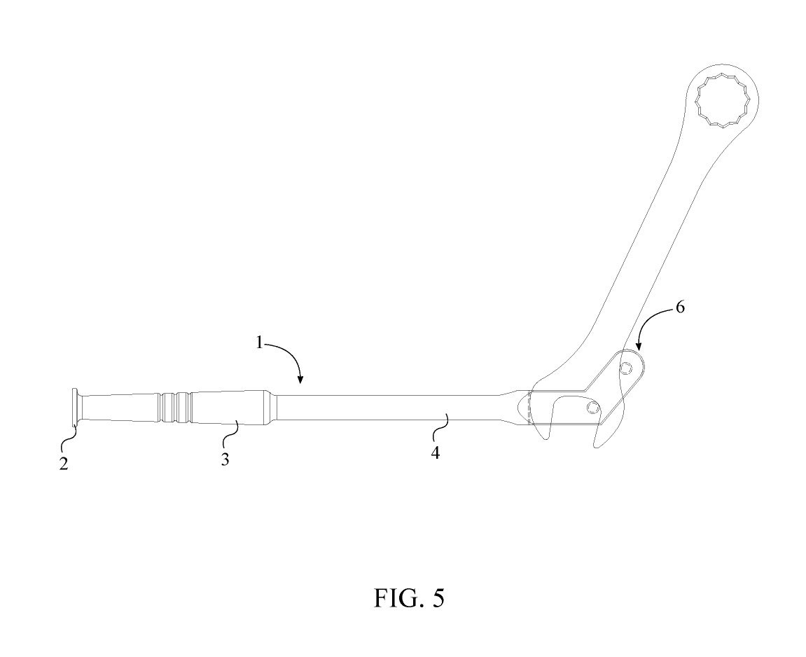

The wrench securing head 6 engages and locks with the open-end wrench so that the user is able to apply pressure to the open-end wrench through the present invention. In reference to FIG. 1-3, the wrench securing head 6 comprises a first lateral plate 7, a second lateral plate 8, and a pair of locking pins 12. The first lateral plate 7 and the second lateral plate 8 provide lateral placement for the present invention with respect to the open-end wrench. More specifically, the first lateral plate 7 and the second lateral plate 8 are connected to the extended section 4, opposite of the grip section 3. Additionally, the first lateral plate 7 and the second lateral plate 8 are diametrically opposed and oriented parallel to each other. As a result of those configurations of the first lateral plate 7 and the second lateral plate 8, the wrench securing head 6 is able to be fully positioned around the open-end wrench. Furthermore, the first lateral plate 7 and the second lateral plate 8 each comprise a straight section 9 and an angled section 10 as shown in FIG. 2. The straight section 9 of the first lateral plate 7 and the straight section 9 of the second lateral plate 8 are connected with the extended section 4. The angled section 10 of the first lateral plate 7 and the angled section 10 of the second lateral plate 8 are respectively connected with the straight section 9 of the first lateral plate 7 and the straight section 9 of the second lateral plate 8. Collectively, the straight section 9 and the angled section 10 of the first lateral plate 7 and the second lateral plate 8 are able to fully enclose both jaws of the open-end wrench when the present invention is utilized. Furthermore, the angled section 10 of the first lateral plate 7 and the angled section 10 of the second lateral plate 8 provide two position angles for the open-end wrench. The two position angles of the present invention are shown in FIG. 4-5 as the two position angles are changed from zero to 90 degree offset with respect to the open-end wrench.

In reference to FIG. 2-3, the pair of locking pins 12 is connected in between the first lateral plate 7 and the second lateral plate 8. More specifically, the pair of locking pins 12 is perpendicularly oriented with the first lateral plate 7 and the second lateral plate 8 and is connected in between the angled section 10 of the first lateral plate 7 and the angled section 10 of the second lateral plate 8. Additionally, the pair of locking pins 12 is extended across an angular axis 11 of the wrench securing head 6, wherein the angular axis 11 positioned parallel to the angled section 10 of the first lateral plate 7 and the angled section 10 of the second lateral plate 8. As a result of the pair of locking pins 12, the present invention can be safely engaged with both jaws of the open-end wrench as one of the locking pin positions external to one of the jaws of the open-end wrench while the other locking pin positions internal to corresponding jaw of the open-end wrench. Furthermore, the present invention differentiates the preferred embodiment of the present invention from the prior art (U.S. Pat. No. 1,689,639) with following miscellaneous features. The prior art U.S. Pat. No. 1,689,639 describes an extension handle for wrenches; however, the extension handle for wrench clearly states, line 20-25, that the extension handle for wrenches can only accommodate up to 5 wrenches. In contrast, the preferred embodiment accommodates two full sets of wrenches, ratchets, and breaker bars in both metric and standard. Additionally, the preferred embodiment also accommodates 10 larger size wrenches.

The extension handle for wrench only allows parallel attachment with the open-end wrenches as shown in FIG. 1-4. However, the preferred embodiment provides a parallel attachment and an angled attachment as shown in FIG. 4-5.

The extension handle for wrench also has a double angled sloped handle, shown as component 15, that grows potentially wider as the extension handle for wrench is made longer. As a result, the extension handle for wrench limits in the length that it can be manufactured according to the double angled sloped handle. In contrast, the preferred embodiment has the extended section 4 that allows the preferred embodiment to be manufactured into any given length while allowing the grip section 3 to maintain a constant size and shape as shown in FIG. 2.

The extension handle for wrench also has a smooth outer surface for the handle proper, which hinders the gripping capabilities. However, the preferred embodiment is completed with the plurality of groves 13 to minimize the slippage as shown in FIG. 2.

The extension handle for wrench clearly shows that the pair of forwardly extending parallel sides extends from the handle proper. As a result, the extension handle for wrench would be required to create different lengths with reasonable proportions of the pair of forwardly extending parallel sides and the handle proper. However, the preferred embodiment clear shows that the extended section 4 separates the grip section 3 and wrench securing head 6, shown in FIG. 2, as the extended section 4 allows different length opportunities for the preferred embodiment.

Although the invention has been explained in relation to its preferred embodiment, it is to be understood that many other possible modifications and variations can be made without departing from the spirit and scope of the invention as hereinafter claimed.

What is claimed is:

1. An extension wrench comprises:
a handle;
a wrench securing head;
the handle comprises a pommel end, a grip section, and an extended section;
the wrench securing head comprises a first lateral plate, a second lateral plate, and a pair of locking pins;
the pommel end being adjacently positioned with the grip section;
the extended section being adjacently positioned with the grip section, opposite of the pommel end;
the first lateral plate and the second lateral plate being connected to the extended section, opposite of the grip section;
the first lateral plate and the second lateral plate being diametrically opposed of each other;
the pair of locking pins being connected in between the first lateral plate and the second lateral plate; and
the pair of locking pins being perpendicularly oriented with the first lateral plate and the second lateral plate.

2. The extension wrench as claimed in claim 1, wherein the pommel end, the grip section, and the extended section being axially oriented along a central axis of the handle.

3. The extension wrench as claimed in claim 1, wherein the first lateral plate and the second lateral plate being oriented parallel to each other.

4. The extension wrench as claimed in claim 1 comprises:
the first lateral plate and the second lateral plate each comprise a straight section and an angled section;
the straight section being adjacently positioned with the angled section;
the straight section of the first lateral plate and the straight section of the second lateral plate being connected with the extended section; and
the pair of locking pins being connected in between the angled section of the first lateral plate and the angled section of the second lateral plate.

5. The extension wrench as claimed in claim 3, wherein the pair of locking pins being extended across an angular axis of the wrench securing head.

6. The extension wrench as claimed in claim 1 comprises:
a plurality of grooves;
the plurality of grooves being distributed along the grip section;
the plurality of grooves being radially positioned around the grip section; and
the plurality of grooves traversing into the grip section.

7. An extension wrench comprises:
a handle;
a wrench securing head;
the handle comprises a pommel end, a grip section, and an extended section;
the wrench securing head comprises a first lateral plate, a second lateral plate, and a pair of locking pins;
the first lateral plate and the second lateral plate each comprise a straight section and an angled section;
the pommel end being adjacently positioned with the grip section;
the extended section being adjacently positioned with the grip section, opposite of the pommel end;
the first lateral plate and the second lateral plate being connected to the extended section, opposite of the grip section;
the first lateral plate and the second lateral plate being diametrically opposed of each other;
the straight section being adjacently positioned with the angled section;
the straight section of the first lateral plate and the straight section of the second lateral plate being connected with the extended section;
the pair of locking pins being connected in between the first lateral plate and the second lateral plate; and
the pair of locking pins being perpendicularly oriented with the first lateral plate and the second lateral plate.

8. The extension wrench as claimed in claim 7, wherein the pommel end, the grip section, and the extended section being axially oriented along a central axis of the handle.

9. The extension wrench as claimed in claim 7, wherein the first lateral plate and the second lateral plate being oriented parallel to each other.

10. The extension wrench as claimed in claim 7 comprises:
the pair of locking pins being connected in between the angled section of the first lateral plate and the angled section of the second lateral plate; and
the pair of locking pins being extended across an angular axis of the wrench securing head.

11. The extension wrench as claimed in claim 7 comprises:
a plurality of grooves;
the plurality of grooves being distributed along the grip section;
the plurality of grooves being radially positioned around the grip section; and
the plurality of grooves traversing into the grip section.

12. An extension wrench comprises:
a handle;
a wrench securing head;
a plurality of grooves;
the handle comprises a pommel end, a grip section, and an extended section;
the wrench securing head comprises a first lateral plate, a second lateral plate, and a pair of locking pins;
the first lateral plate and the second lateral plate each comprise a straight section and an angled section;
the pommel end being adjacently positioned with the grip section;
the extended section being adjacently positioned with the grip section, opposite of the pommel end;
the first lateral plate and the second lateral plate being connected to the extended section, opposite of the grip section;
the first lateral plate and the second lateral plate being diametrically opposed of each other;
the straight section being adjacently positioned with the angled section;
the straight section of the first lateral plate and the straight section of the second lateral plate being connected with the extended section;
the pair of locking pins being connected in between the first lateral plate and the second lateral plate;
the pair of locking pins being perpendicularly oriented with the first lateral plate and the second lateral plate;
the plurality of grooves being distributed along the grip section;
the plurality of grooves being radially positioned around the grip section; and
the plurality of grooves traversing into the grip section.

13. The extension wrench as claimed in claim 12, wherein the pommel end, the grip section, and the extended section being axially oriented along a central axis of the handle.

14. The extension wrench as claimed in claim 12, wherein the first lateral plate and the second lateral plate being oriented parallel to each other.

15. The extension wrench as claimed in claim 12 comprises:
the pair of locking pins being connected in between the angled section of the first lateral plate and the angled section of the second lateral plate; and
the pair of locking pins being extended across an angular axis of the wrench securing head.
